(19) United States
(12) Patent Application Publication
(10) Pub. No.: US 2009/0216807 A1
(43) Pub. Date: Aug. 27, 2009

(54) MEDICAL DATA EVALUATION AND DISTRIBUTION

(75) Inventors: D. Noah Roberts, Tulsa, OK (US); Jonathan Bartlett, Broken Arrow, OK (US); Michael E. Stuart, Seattle, WA (US); Sheri Strite, Portland, OR (US)

Correspondence Address: FISH & RICHARDSON P.C., P.O. BOX 1022, MINNEAPOLIS, MN, 55440-1022, US

(73) Assignee: Docvia.com, LLC, Tulsa, OK (US)

(21) Appl. No.: 12/252,052

(22) Filed: Oct. 15, 2008

Related U.S. Application Data
(60) Provisional application No. 61/031,677, filed on Feb. 26, 2008.

(51) Int. Cl. G06F 17/30

(52) U.S. Cl. 707/104.1; 707/E17.02

(57) ABSTRACT

Systems and processes may facilitate evaluating medical data and distributing the results. In particular implementations, systems and processes may guide appraisers through the process of identifying medical articles regarding medical issues (e.g., medical reports on disease and/or treatment topics) for appraisal, and then through the process of critically appraising medical articles on the merits of their scientific evidence. The systems and processes may then take the appraisals and present them in an easy-to-digest format for an end-user. Additionally, the systems and processes may maintain an active link to the original data sources so that users can see what new developments are taking place with respect to the medical issue.

### CLAIM OF PRIORITY

This application claims priority under 35 U.S.C. §119 to U.S. Patent Application No. 61/031,677, filed on Feb. 26, 2008, the entire contents of which are hereby incorporated by reference.

### TECHNICAL FIELD

The present invention relates to medical data appraisal and distribution.

### BACKGROUND

Although medical data (e.g., from studies, tests, and appraisals) is being produced at an ever increasing rate, society has yet to see a substantial portion of the benefits from such data. Part of the problem is due to the fact that medical data is being produced so quickly that it is difficult to appraise. The National Library of Medicine, for example, adds approximately 10,000 new articles every week.

But it turns out that volume only tells a part of the story. Many, if not most, of the new reports are reporting medical data that has not had appropriate scientific controls applied to the data's derivation. While the data that these articles is reporting is not necessarily wrong, it has not been proven that rigorous scientific standards have been applied in obtaining this data. Thus, it may be inappropriate to draw any broad conclusions based on the articles, especially if secondary considerations are not taken into account.

The lack of scientific controls can also lead an article to reflect just the “conventional wisdom” of the medical community or the biases of the researcher. Unfortunately, the conventional wisdom can often be wrong, and researcher's biases can distort results.

Perhaps just as troubling is the number of articles that a lay person can retrieve from searching the web through popular search engines (e.g., Google, Yahoo, or Lycos). The average lay person has no means to appraise the scientific merit of these articles and can easily be misled by the conclusions.

### SUMMARY

This disclosure relates to systems and processes for evaluating medical data and distributing the results. In particular implementations, systems and processes may guide appraisers through the process of identifying medical articles on one or more disease and treatment topics for appraisal, and then through the process of critically appraising the medical articles on the merits of their evidence. The systems and processes may then take the appraisals and present them in an easy-to-digest format for an end-user. Additionally, the systems and processes may maintain an active link to the original data sources (e.g., PubMed) so that appraisers and users can determine what new developments are taking place in the disease/treatment topic, even before the reports are appraised. The systems and processes may also produce a customized search system.

Additionally, the systems and processes may produce a set of annotations for use by search engines, thus providing the search engines a list of sites that are considered authoritative for the disease topics. This allows search engines that have the ability to customize rankings and results to use the material entered for evidence-based search.

In some implementations, a user request for information related to a medical topic may be received. A summary of the medical topic, a listing of reports related to the medical topic, and indications of results of evidence-based medicine appraisals of the reports may be retrieved. The listing of reports may include reports appraised based on evidence-based medicine rules. A user interface may be generated to present the summary, the listing of reports, and the appraisals.

Various implementations may include one or more or none of the following. The user request may include search criteria, and a medical topic associated with the search criteria may be identified. A second user request to appraise one of the reports in the listing of reports may be received, and an interface may be generated to present the evidence-based medicine appraisal of the report. The medical topic may include at least one of medical conditions, symptoms, diagnoses, or treatments. Evidence-based medicine rules may include rules based on at least one of sample size, bias, control group, or length of study. The interface may be generated to present grades of reports presented on the listing of reports. A grade of a report may be based on an appraisal of the report according to evidence-based rules. An order of reports in the listing of reports may be at least partially based on the grades of the reports. At least one of the reports in the listing of reports may include an annotation, and information related to the appraisal of the report may be presented based on the annotation, when receiving a request for the information related to the appraisal. A request for appraisals for the reports in the listing of reports may be received, and the appraisals for the reports may be transmitted to a user device. Generating an interface to present the listing of reports may include generating an interface to present reports with a grade greater than a specified value, where a grade of a report may be based on an appraisal of the report according to evidence-based rules. Medical topic search criteria may be stored, the summary of the medical topic may be at least partially based on results of the search criteria, and the stored search criteria may be automatically submitted after a receiving a user request for information related to the medical topic. A second search result based on the submitted search criteria may be received, and reports may be identified that were included in the second search result and not included in a previous result based on the search criteria.

In some implementations, search criteria related to a medical topic may be received and a search for reports related to the search criteria may be generated. The search results based on the generated search may be received, where the search results include a listing of reports. An interface may be generated to present one or more reports in the listing of reports. One or more assignments may be received for one or more of the reports in the listing of reports to appraisers for appraisal based on evidence-based medicine rules. A notification that an appraisal of one or more of the reports in the listing of reports has been appraised based on evidence-based medicine rules may be received, and an interface may be generated to present one of more of the appraisals. A summary of the medical topic based at least in part on the appraisals may be received.

Various implementations may include one or more or none of the following. The medical topic may include at least one of medical conditions, symptoms, diagnoses, or treatments. Evidence-based medicine rules may include rules based on at least one of sample size, bias, control group, or length of study. Search criteria may be stored and automatically submitted after a specified period of time. Second search result may be received, and reports may be identified that were included in the second search result and that were not included in a previous result based on the search criteria. A notice related to the identification of reports that were not included in a previous search result may be transmitted. The identified reports may be automatically assigned based on previous assignments of reports in the previous search results. Previous search results may be stored, where the identification of reports that are included in the second search result that were not included in a previous result may include comparing the second search results to stored previous search results. One or more medical terms related to the medical topic may be received and the received summary may be associated with one or more of the medical terms, such that when a search including one or more of the medical terms is performed, the summary may be retrieved. A template may be generated that is configured to receive rules for evidence-based medicine appraisals of the received listing of reports. One or more rules may be received to generate the template, and the generated template and received assignments may be transmitted to one or more of the appraisers.

In some implementations, a listing of reports, related to a medical topic and assigned to an appraiser, may be received and transmitted to the appraiser to whom the listing is assigned. Appraisal rules may be received, where the appraisal rules may be utilized in the appraisal of reports according to evidence-based medicine rules. Appraisal rules may be transmitted to the appraiser to whom the listing is assigned, and an appraisal of one of the reports based on the received rules may be received. An annotation of the report may be received, where the annotation may include information related to the appraisal; and, the annotation may be associated with the report, such that when the report is presented the associated annotation is retrievable.

Various implementations may include one or more or none of the following. The medical topic may include at least one of medical conditions, symptoms, diagnoses, or treatments. Evidence-based medicine rules may include rules based on at least one of sample size, bias, control group, or length of study. The received appraisal may be stored. A notice may be transmitted to the appraiser related to receiving the listing of reports. A notice may be transmitted to a chief appraiser when appraisals for the reports in the listing of reports assigned to the appraiser have been received. The appraisal rules may include rules related to a grade assigned to a report, and receiving an appraisal of the report may include receiving a grade for the report. The annotations may include at least one of the search terms utilized to obtain the listing of reports related to a medical topic, a date when the search terms were utilized to obtain the listing of reports, appraiser identification information, chief appraiser identification information, reasons for grades, or appraiser notations.

In some implementations, an article of manufacture may include a machine-readable medium (e.g., magnetic or optical computer memory) that stores instructions for managing medical information. The instructions may be operable to cause data processing apparatus to perform operations including at least a portions of the operations performed in various implementations.

Various implementations may include one or more features. For example, on-line search results for various medical topics may be appraised via evidence-based medicine techniques, which may provide a technical and systematic analysis of a medical topic. As another example, summaries and appraisals by topic may be generated. The summaries may provide user-friendly information regarding the medical topics, and the appraisals may allow users to ascertain how relevant summaries are. Search results may also be updated automatically, which may provide another manner in which to ascertain the relevancy of summaries.

The details of one or more implementations are set forth in the accompanying drawings and the description below. Other features will be apparent from the description and drawings, and from the claims.

### DESCRIPTION OF DRAWINGS

FIG. 1A is a block diagram illustrating a system for evaluating and distributing medical data.

FIG. 1B is an example system for evaluating and distributing medical data.

FIG. 2A is a flow chart illustrating a process for evaluating and distributing medical data.

FIG. 2B is a flow chart illustrating a process for searching for medical data.

FIG. 3 is an example of a user interface illustrating the management of search results through a primary appraiser device.

FIGS. 4A-I are an example of a user interface illustrating a search result and the current status of appraising the search results.

FIGS. 5A-B are an example of a user interface illustrating the process for evaluating whether a study is relevant through an appraiser device.

FIGS. 6A-B are an example of a user interface illustrating the appraisal of a report through an appraiser device.

FIG. 7 is an example of a user interface illustrating the grading of a report through an appraiser device.

FIGS. 8A-B are an example of a user interface illustrating the preparation of a summary through a primary appraiser device.

FIGS. 9A-C are an example of a user interface illustrating an information site for users.

FIG. 10 is an example of a user interface illustrating another information site for users.

Like reference symbols in the various drawings indicate like elements.

### DETAILED DESCRIPTION

Reliably evaluating medical data and distributing the results of the appraisal may provide substantial benefits to individuals and society at large. In particular implementations, a system, which may include one or more devices and/or articles of manufacture, and process may facilitate the appraisal and distribution of medical data. The system and process may, for example, assist in the identification, collation, appraisal, distribution, and revalidation of the medical data.

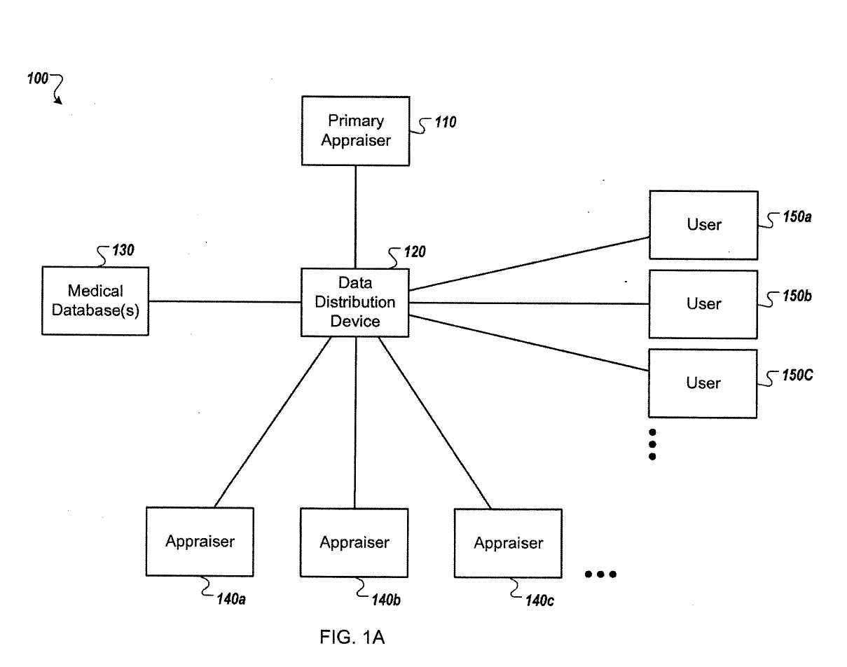

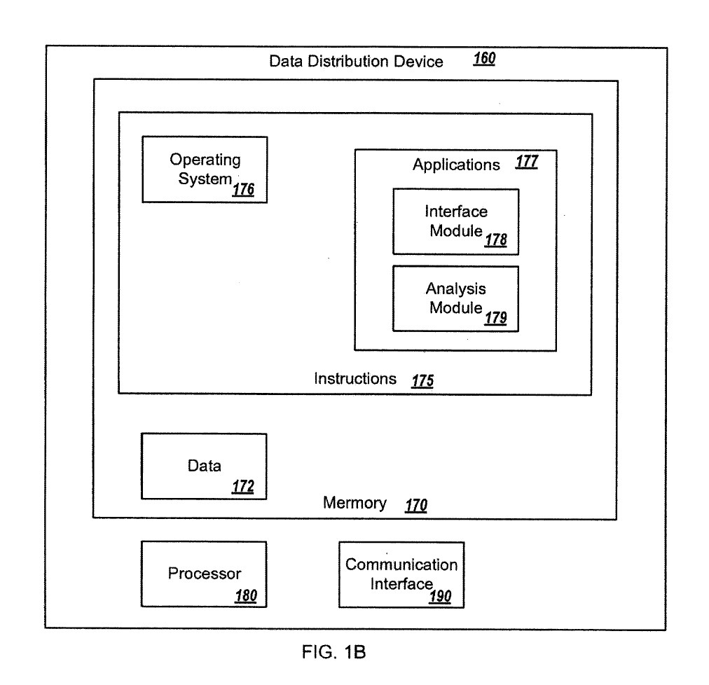

FIG. 1A illustrates a system 100 for evaluating and distributing medical data. In general, system 100 includes a primary appraiser device 110, a data distribution device 120, one or more medical databases 130, and appraiser devices 140. Using the primary appraiser device 110, the primary appraiser may formulate a set of searches to retrieve relevant reports (e.g., articles, studies, trials, tests, or any other compilation of medical material) for a disease (e.g., cancer), body part (e.g., back), treatment regimen (e.g., chemotherapy), or other appropriate medical topic. The searches may be submitted to the medical database(s) 130 through data distribution device 120. The results of the searches are returned to the data distribution device 120 for appraise at the primary appraiser device 110 and assignment to appraisers at the appraiser devices 140. The appraisers may, for example, have expertise in medicine (e.g., MDs), pharmacy, epidemiology, biostatistics, nursing, or other allied health professions. The appraiser devices 140 assist the appraisers in evaluating the reports for scientific merit. As the appraisers finish evaluating the medical reports, the appraiser devices 140 transmit the results to the data distribution device 120. The primary appraiser can then use the primary appraiser device 110 to appraise the appraisals to identify the medical data that has scientific merit and produce a summary of the scientific findings on the medical topic. The summary and findings are stored at the data distribution device 120, from which they can be provided to user devices 150.

In more detail, the primary appraiser device 110, the appraiser devices 140, and the user devices 150 may be any appropriate devices for accessing electronic data. For example, the devices may be personal computers, laptops, and/or personal digital assistants. The devices may operate using a micro-processor operating according to software (e.g., operating system, applications, and utilities) that is loaded in random-access memory and/or read-only memory. The devices may have any appropriate user-input devices (e.g., a keyboard, a touchpad, a mouse, and/or a stylus) and user-output devices (e.g., a display, speakers, and/or a tactile generator). The devices may, for example, present the data from the data distribution device 120 through a customized user interface application or through a general application (e.g., a web-browser).

The data distribution device 120 may be any appropriate device for collecting and distributing data. For example, the data distribution device 120 may include one or more servers (implemented in hardware and/or software) having or coupled to databases that store the medical data and provide it to the users. In particular implementations, the data distribution device 120 may include a web-site for access by the various devices.

FIG. 1B illustrates an example data distribution device 160. As illustrated, the data distribution device includes memory 170, a processor 180, and a communication interface 190, which facilitates communications with other devices such as primary appraiser device 110, medical databases 130, appraiser devices 140 and/or user devices 150. The memory 170 may store data 172. The data 172 may, for example, include search criteria, search results, assignments, reports, listings of reports, links to reports, listings that include links to reports, appraiser information, appraisals, appraisal rules, templates of appraisal rules, annotations, summaries, medical terms associated summaries and/or medical topics, etc. The memory may also store instructions 175 executable by the processor 180. As illustrated, instructions may include operating systems 176 (e.g., Linux, Unix, or Windows) and applications 177 such as an interface module 178 and an analysis module 179. The interface module 178 may generate an interface (e.g., a website) to facilitate interaction with users, appraisers, chief appraisers, etc.

The analysis module 179 may evaluate and distribute medical data. For example, the analysis module 179 may receive search criteria (e.g., medical topic search criteria that may be used to identify reports related to a medical topic), and use the search criteria (e.g., by submitting the search criteria to a medical database) to retrieve search results such as listings of reports. The analysis module 179 may use search criteria provided by a user to provide information related to a medical topic related to the search criteria. The analysis module 179 may analyze search criteria provided by a user to identify the medical topic to which the search criteria relates and/or to retrieve a summary of the medical topic. The analysis module 179 may receive requests for appraisals of reports and retrieve the requested report. The analysis module may receive requests for access to annotations associated with reports, access to evaluations of reports that have been appraised, and/or access to other data retrievable by the data distribution device. The analysis module may retrieve this requested data and transmit and/or present the information to the requesting party. In addition, the analysis module 179 may manage the order in which reports are presented in response to a search request (e.g., based on evaluation). For example, in the generation of a listing of reports that satisfy a user's search criteria, the analysis module 179 may analyze evaluations (e.g., grades) of the reports in the listings and sequence the listing of reports based on the analysis of the grades (e.g., higher graded results may be highlighted or otherwise marked and/or presented higher in a sequenced listing).

The analysis module 179 may also receive search criteria related to a medical topic and submit the search criteria to receive search results. The analysis module 179 may manage assignments of reports to chief appraisers and/or appraisers. For example, the analysis module 179 may receive assignments and/or automatically assign reports based on previous assignments. The analysis module 179 may also generate and/or transmit (e.g., using the communications interface 190) notifications related to outstanding appraisals to be performed, completed appraisals, new reports, etc. The analysis module 179 may, in some implementations, associate summaries, annotations, and various medical terms with these items.

In particular implementations, the analysis module 179 may additionally receive information related to appraisal rules to be used in appraisals of reports based on evidence-based medicine rules. The analysis module 179 may generate templates based on the received information and/or transmit the templates and/or received information to appraisers. The analysis module 179 may, in connection with the interface module, generate interfaces for presentation of various items of information to users, appraisers, and/or chief appraisers.

The medical database(s) 130 may be any appropriate storage facilities for medical data, whether public or private. In particular implementations, the medical database(s) 130 may include PubMed Central (PMC), which is operated by the U.S. National Institutes of Health (NIH).

The various components of system 100 may be coupled together by any appropriate wire line and/or wireless communication network(s). In particular implementations, the components may be coupled together through the Internet.

In one mode of operation, the primary appraiser device 110 allows the primary appraiser to access the data distribution device to formulate searches for reports (e.g., studies, data, and/or articles) on medical topics (e.g., diseases, conditions, or treatments). The searches are submitted to the medical database(s) 130 by the data distribution device 120, and the results are stored at the data distribution device and relayed to the primary appraiser device 110.

If the searches return relevant reports, the primary appraiser may use the data distribution device to assign the reports to the appraisers for appraisal. The appraisers may be notified that reports are awaiting appraisal when they log on to the data distribution device 120 and/or through a messaging service (e.g., e-mail, SMS, etc.). The relevant searches and their retrieved results are saved for later use.

As a further example, the primary appraiser may be informed when disease/treatment topics have new reports waiting for appraisal based on the saved searches of the information sources. This may allow the primary appraiser to easily update evidence summaries with new data as it comes becomes available. A workbench may be generated to inform the appraiser of the new reports. Thus, the update process may be accomplished through a single tool.

The appraisers may appraise one or more reports. In some implementations, reports may be accessed from the data distribution device 120 through appraiser devices 140. Access to the reports may be provided through links (e.g., hyperlinks) adapted to retrieve the reports from various medical databases. For example, the data distribution device may generate and transmit to an appraiser a link to an article available through PubMed to provide appraisers with access to reports. The reports may also be available from the data distribution device.

In appraising a report, an appraiser may determine whether a report is relevant to the medical issue they are appraising (e.g., by appraising the abstracts). For example, pharmaceutical treatments for a condition may not be relevant to an issue regarding physical therapy for the condition.

The appraiser may then appraise the report to determine if scientific evidence exists to support its conclusions (e.g., an analysis of the report using evidence based medicine rules may be performed). For example, the appraiser may examine whether the data is based on an appropriate sample size, whether a control group was used, and whether the test subjects were monitored for a sufficient period of time. General categories may include the study type, the funding source, the aim, the outcome measures technique, the definitions, the duration, the intervention, the sample size, the power, the population as actually studied, the inclusions, the exclusions, the baseline characteristics analysis, the randomization, the concealment of allocation, the blinding, the run-in period, the washout period, the concomitant medication usage, the disallowed medications, the adherence, the measurement methods, the quality control procedures, the deviations from protocol, the safety population, the confounders, the efficacy, the safety, the conclusions, the economics, and/or the quality of reporting. The appraiser devices 140, in conjunction with the data distribution device 120, may guide the appraisers through the appraisal process by presenting appropriate questions and input sections and verifying that the appraiser has answered pertinent questions. A summary and an evaluation may then be generated for each report. The appraisals, summaries, and evaluations are stored at the data distribution device 120.

Once one or more reports have been analyzed, the primary appraiser may access the appraisals through the primary appraiser device 110 and appraise the results of each appraisal. Using the primary appraiser device 110, the primary appraiser may determine the overall weight of the evidence for the medical issue being examined and create a summary of the evidence.

System 100 may provide one or more outputs from this process. For example, data for an informational site (e.g., a web-site) may be generated for users desiring information about a medical issue—the evidence for the efficacy of treatments for a disease, for instance. The users may access the informational site through their user devices 150. At the site, the users may search for medical conditions, diseases, and/or treatments. The search may be conducted using any appropriate search technique. In particular implementations, for example, Google™ Custom Search may be used.

Additionally, using the saved search searches and results, the informational site may also show new, though not yet appraised, reports as they become available. This may be achieved by reissuing the searches in the future when a user views a summary and comparing the results to a list of appraised reports to generate new items that have not been examined or appraised. This may let the user know the state of the evidence, what those rankings are based on, as well as what the latest data is.

As another example, a set of annotations for use by search engines for doing searches on medical treatments that are evidence-based may be generated. The annotations may include information identifying the medical database that a search utilized, the reports that were found to be evidence-based in the appraisal process, and their associated appraisals. This may provide systematic appraise to search results for search engines, allowing them to weigh search results by the validity of appraised medical reports.

System 100 has a variety of features. For example, the system may provide on-line search results that include results based at least in part on evidence-based medicine evaluation techniques. As part of this, the system may produce user-friendly summaries and appraisals by topic. The system also may allow users and appraisers to ascertain whether the summaries are still relevant based on the current state of research. Additionally, the system may provide transparency in the process as the underlying data and motivations for the appraisal process and summary—search strategies (e.g., engine, time frame, terms), reports, appraisals, appraisers, and reasons for the study (e.g., safety, efficacy, economics, etc.), for example—may be reviewable by users.

As another example, the system may provide a way to efficiently and accurately generate the appraised medical reports. For instance, since a large volume of reports are published, the system may facilitate access to relevant reports for users by identifying the reports that are relevant to a medical topic and have an appropriate scientific basis for results identified in the reports (e.g., determined using evidence-based medicine rules). The system may also assist in making sure that all of the relevant reports are appraised. In addition, by identifying new and relevant reports, the accuracy of a summary may be obtained (e.g., when a new study that contradicts conventional wisdom, which may be reflected in a summary, is published and appraised, it may be easily identified by users through the system).

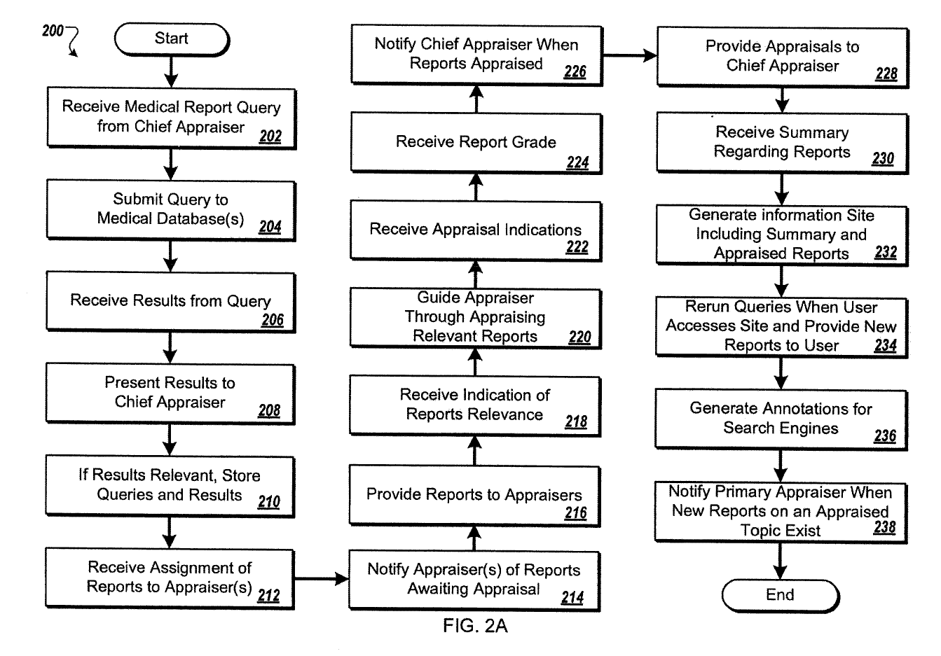

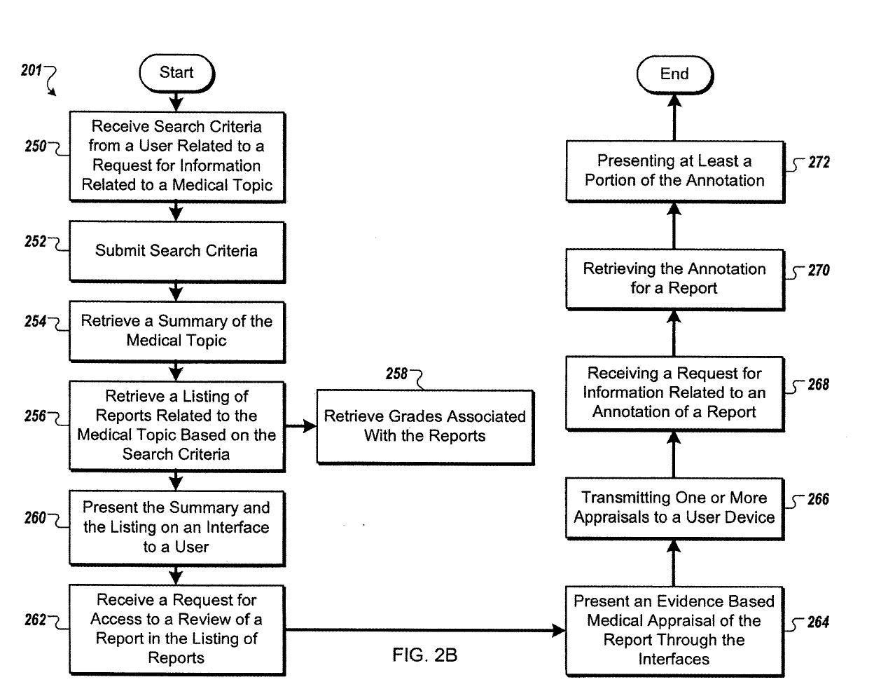

FIG. 2A illustrates one example of a process 200 for evaluating medical data and distributing the results. Process 200 may, for example, be implemented by a system similar to system 100. A chief appraiser, who may be responsible for one or more specified medical topics, may use his device to identify one or more medical report search terms to utilize in a search of medical databases. A medical report search may then be received from the chief appraiser (operation 202). For example, the chief appraiser may formulate a search for a medical topic such as asthma. As another example, the chief appraiser may formulate a search criteria for a medical topic such as vitamin D deficiency. The chief appraiser may specify search criteria such as the search engine, type of study (e.g., RCT), the time frame, terms, mesh terms, etc. The chief appraiser may then use his/her device to transmit this search to the data distribution device. The chief appraiser may also transmit information related to the appraisal of a medical topic such as why the study is being performed—for example, to determine the safety, efficacy, and/or economics of a treatment. The chief appraiser may access an interface (e.g., through the Internet) that is coupled to the data distribution device. The data distribution device may receive medical report search terms to be executed on a medical database from a chief appraiser device.

The search criteria may be submitted to medical database(s) (operation 204). For example, the search may be submitted to PubMed and/or Science Direct. Search results may be received (operation 206). The search results may include a listing of reports that satisfy the medical report search. The received search results may be presented to the chief appraiser (operation 208). For example, the search results may be displayed through a user interface.

The search and the search results (e.g., listing of reports, report information, reports, links to reports, etc.) may be stored, if the results are relevant (operation 210). For example, the search and the results may be stored if a determination is made that one or more of the reports included in the results will be appraised by an appraiser. As another example, the search and/or the results may be stored if a determination is made that execution of the search produced reports related to the medical topic.

Assignments of the reports or portions thereof to one or more appraisers may be received (operation 212). The chief appraiser may assign the reports or portions (e.g., reports) thereof to appraisers through an interface of the system.

Appraisers may be notified of reports awaiting appraisal (operation 214) and the reports may be provided to the appraisers (operation 216). For example, the appraiser may log into an interface and receive notification of his/her assignments. The reports associated with the assignments may then be retrieved and presented to the appraiser through the interface.

An indication of relevance of the presented report may be received (operation 218). For example, the chief appraiser may classify the appraised item as unexamined, included, or excluded. The chief appraiser may also provide a reason that the indication of relevance was assigned to the appraised item. For example, the chief appraiser may classify an report as excluded and indicate why the report was excluded (e.g., due to improper participants in the study or bias).

The appraiser may be guided through appraising the relevant reports (operation 220). For example, the interface may include rules for evaluating reports based on evidence medicine rules (e.g., rules generally accepted within the medical community for rigorous studies, rules related to sample size, bias, control groups, length of study, randomness of sample, etc.). The appraisals may also identify threats to the reports (e.g., issues with the report that threaten the validity of the results of the report).

Appraisal indications may be received (operation 222). An appraiser may submit appraisals or appraisals for each report assigned to the appraiser. The appraisers may submit the appraisals through an interface configured to receive the appraisal.

Report grades may be received (operation 224). Each report appraised may be associated with a grade by the appraiser. For example, a report may be associated with a letter grade (e.g., A, B, C, etc.; or A+, A, A−, B+, etc.). As another example, the report may be graded based at least on efficacy and/or safety. As another example, the report may be graded based on various classifications of the quality of the evidence such as certain, possibly certain, uncertain if useful, or uncertain with respect to the relatedness of the report to a specified topic.

The chief appraiser may be notified when the reports or a portion of the reports have been appraised (operation 226). For example, a message may be generated and/or transmitted to the chief appraiser when an appraiser has completed an appraisal of a report, a listing of reports, a report, or multiple reports. A chief appraiser may be notified when a selected set of reports has been completed (e.g., when reports relate to a specified medical topic).

The appraisals may be provided to the chief appraiser (operation 228). The chief appraiser may be presented the appraisals through the interface. The chief appraiser may then appraise the presented appraisals and prepare a summary related to the reports. For example, the chief appraiser may appraise the report appraisals related to a medical topic and prepare a summary of the medical topic. The summary may be received (operation 230).

An information site including the summary and appraised reports may be generated (operation 232). For example, an interface may be generated that provides access to the summary, appraisals, and/or reports. The medical report searches may be rerun when a user accesses the site and new reports may be provided to the user (operation 234).

Annotations for the search engines may be generated (operation 236). The annotations may associate medical terms with the summary, a medical topic, and/or relevant reports. The appraisers may also provide annotations related to the appraisal of a report. These annotations may be accessible by a user through the interface. The annotations may provide a degree of transparency for users which may increase the confidence and decrease the appearance of bias in the summary and/or grades.

Primary or chief appraisers may be notified when new reports on an appraised medical topic exist (operation 238). For example, the medical report search may be stored and re-executed at specified times and/or when a chief appraiser requests that the medical report search is re-executed. The new reports on the new search results received may then be identified (e.g., reports on the new search results may be compared to the reports on a stored listing of reports that have been appraised and/or that are associated with a previous execution of the medical report search). The system may automatically assign the new reports based on the previous assignments of the reports related to the medical report search.

Various operations may be added, deleted, modified, or reordered in various implementations. For example, medical report searches may not be re-executed. As another example, grades may not be provided or received for each report. As another example, individual reports may be assigned to appraisers rather than reports. As another example, appraisers may be provided with summaries of the status of appraisals (e.g., unassigned, assigned, complete, etc.). The status may be indicated with various indicia (e.g., color codes). Biography information related to the appraisers and/or chief appraisers may be received and/or stored by the data distribution device. Storing the biography information and providing at least a portion of the biography information to users may increase the transparency of the system, which may increase user confidence in the system and/or processes.

In addition, a template for evaluating the reports according to evidence-based medicine rules may be generated. For example, the chief appraiser may provide information through the interface related to the rules that should be applied when appraising a report related to a medical topic. This provided information may be utilized to create a template on the interface utilized by the appraisers. This template may guide the appraiser through an evidence-based medicine appraisal of a report. The template may include fields configured to receive answers to various rules and/or drop down menus that may provide a listing of available answers. The templates may include one or more or none of drop-down fields, free-text fields, radio buttons, branching answers, options to add and/or delete fields, and/or tips (e.g., industry standards such as a specified type of study is usually considered satisfactory when it has more than 50 participants). In some implementations, the templates may be stored and a library of templates may be generated. A chief appraiser may then retrieve a template from the library and utilize the saved template or a self-customized version of the saved template. Utilizing a template may increase the standardization of the appraisal of reports across multiple appraisers and/or increase the ease with which users that access the appraisals through various searches on medical topics can understand the appraisals. As another example, the reports may be provided to the appraisers (e.g., reports may be stored in the data distribution device and/or links to the reports may be provided by or through the data distribution device to the reports).

The summaries, appraisals, search terms, and/or reports generated may be stored and accessible by users. For example, users such as doctors researching various topics, users such as patients with various conditions, and/or users such as insurance companies interested in the efficacy of a treatment, may seek access to these stored items through the Internet, for example. An interface, such as a search interface similar to Google, may be utilized to provide access to this stored information.

In some implementations, chief appraisers may provide (e.g., to the data distribution device) tags associated with the reports. The tags may identify why the reports was included in the study, notes to an appraiser, and/or other appropriate information. The tags may be for internal use and users (e.g., users accessing summaries, non-appraisers) may be inhibited from accessing the tags.

FIG. 2B illustrates one example of a process 201 for evaluating medical data and distributing the results. Process 201 may, for example, be implemented by a system similar to system 100. Search criteria, related to a request for information related to a medical topic, may be received from a user (operation 250). For example, a user may submit “sciatica treatments” as search criteria.

The search criteria may be submitted, for example, to the data distribution device (operation 252). A medical topic may be identified based on the submitted search terms. For example, various medical terms (e.g., provided by appraisers or the chief appraiser) may be associated with specified medical topics. Thus, medical topics may be identified based on the search and a summary of the identified medical topic may be retrieved (operation 254).

A listing of reports related to the medical topic may be retrieved based on the search criteria (operation 256). For example, the search terms may be executed on the data distribution device to identify reports associated with the medical topic associated with search terms (e.g., annotations include the search terms, the reports include the search terms, etc.). The listing of reports may then be generated based on the execution of the search criteria. Grades associated with the reports may also be retrieved (operation 258). The listing of reports may be sequenced at least partially based on the grades.

The summary and listing of reports may be presented to the user on an interface (operation 260). A request for access to an appraisal of a report in the listing of reports may be received (operation 262). For example, a user may select a link to request retrieval of an appraisal associated with the report. The availability of the appraisal utilized in creating the summary may increase the transparency of the data distribution system, which may increase the end user's confidence in the accuracy of the data being presented.

An evidence-based medicine appraisal of a report may be presented through the Interface (operation 254). The appraisal may be in a template form and the uniformity in the presentation of the appraisals may increase ease of use and understandability of the appraisal for the user. One or more of the appraisals may be transmitted to a user device (operation 256). For example, a user may download appraisals for one report or for the presented reports that satisfy the search criteria.

A request for information related to an annotation of a report may be received (operation 268) and the annotation for the report may be retrieved (operation 270). A user may desire more information than just the appraisal of the report. Appraisers may provide information (e.g., search strategy, appraisers notes, etc.) that is utilized to generate the annotations associated with a report. The annotation or a portion thereof may be presented (operation 272).

Various operations may be added, deleted, modified, or reordered in various implementations. For example, annotations may not be presented, but information may be presented to a user based on the annotation of an report. As another example, a medical topic may not be automatically identified, but a user may provide or select a medical topic that the user would like to search.

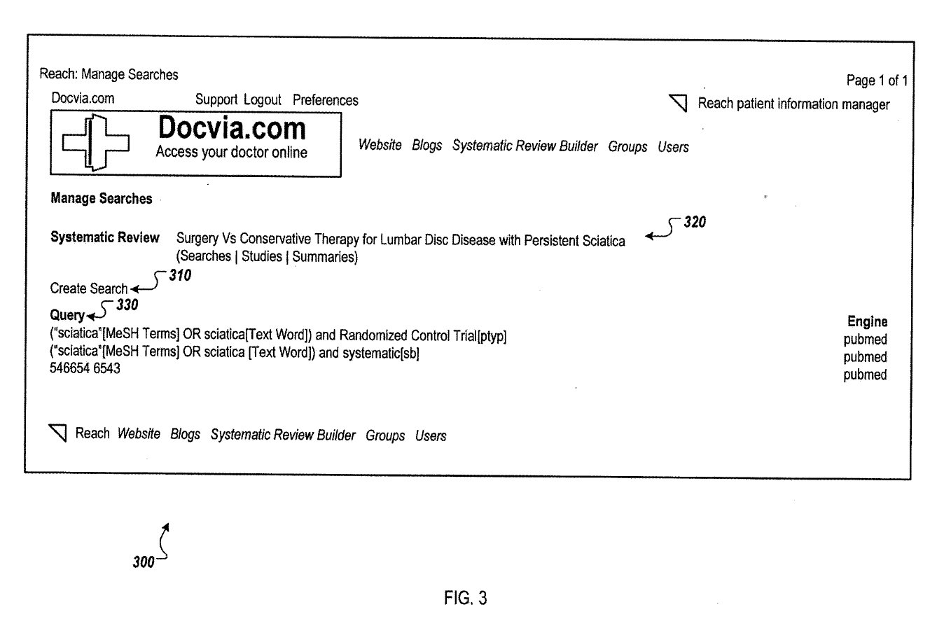

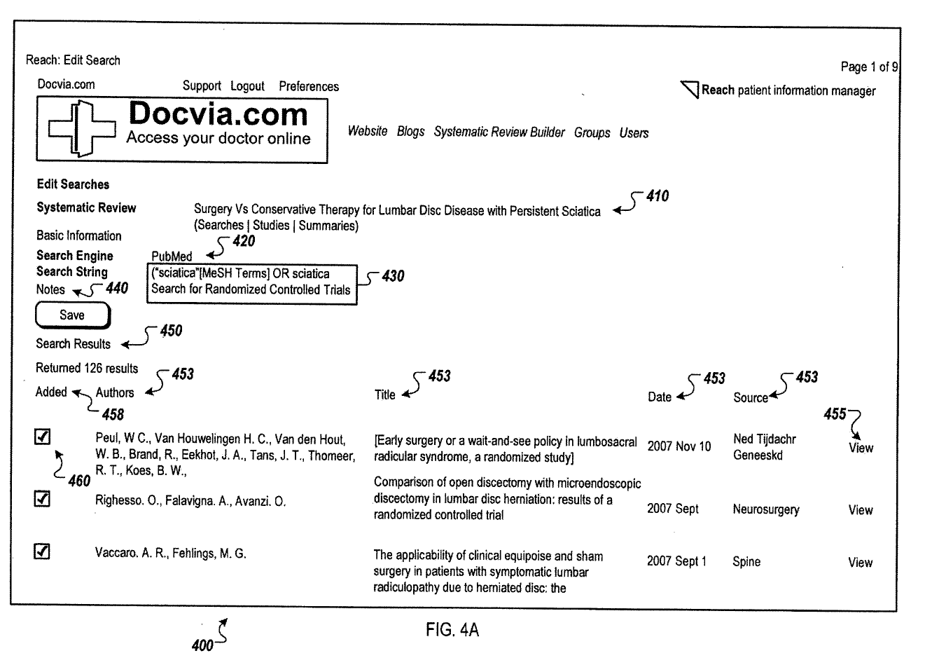

FIG. 3 is an example of a user interface 300 illustrating the management of search results through a primary or chief appraiser device. As illustrated, a chief appraiser may create searches utilizing a search link 310, view current appraises 320, and/or view search results 330.

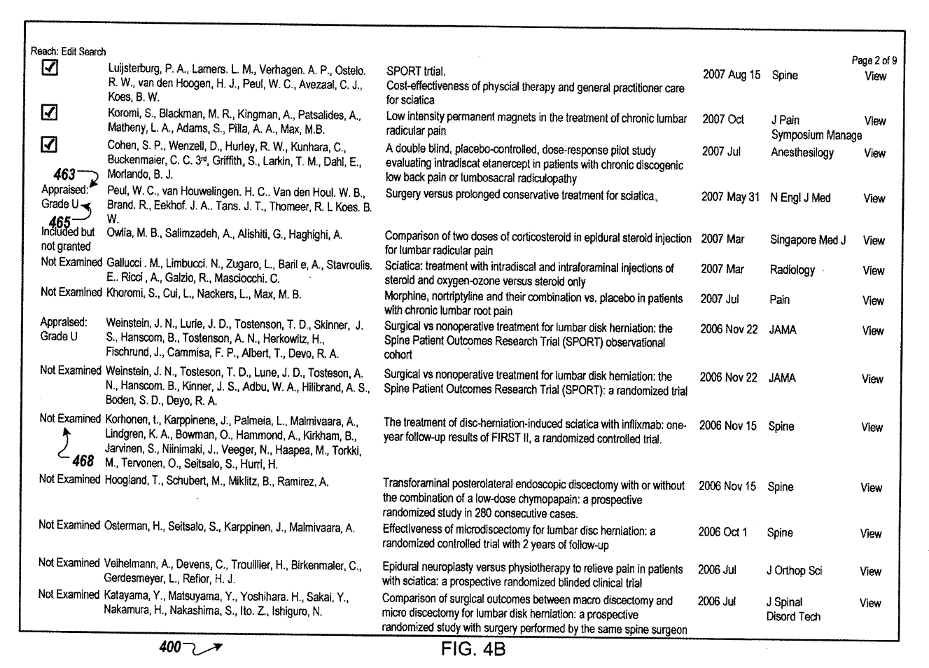

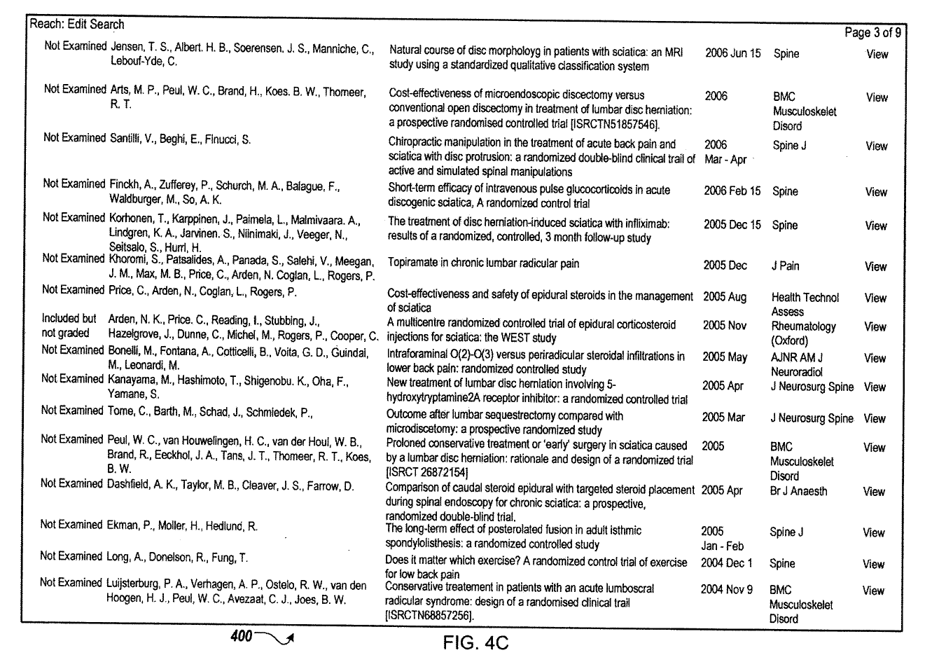

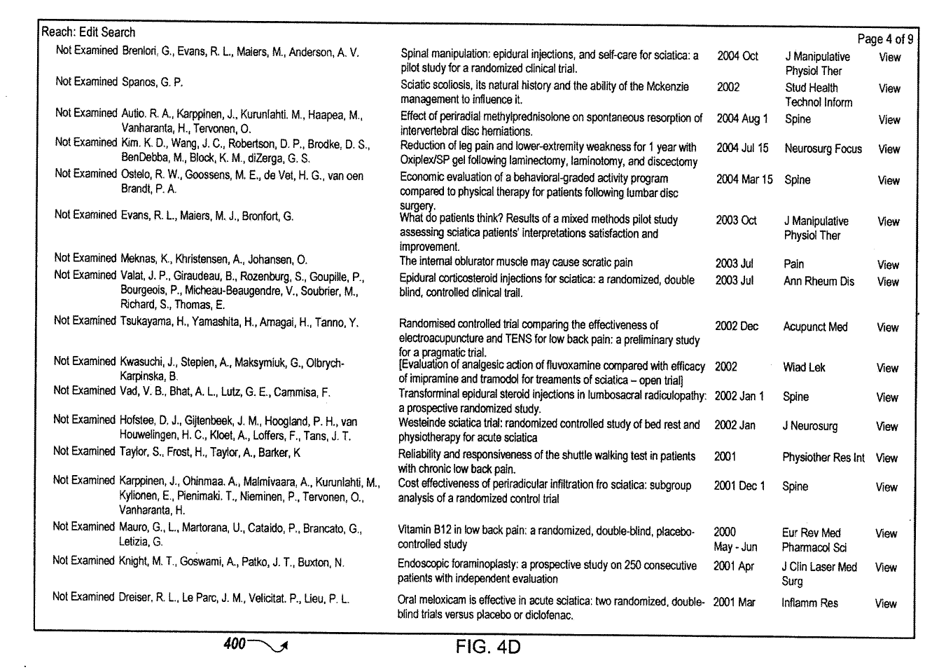

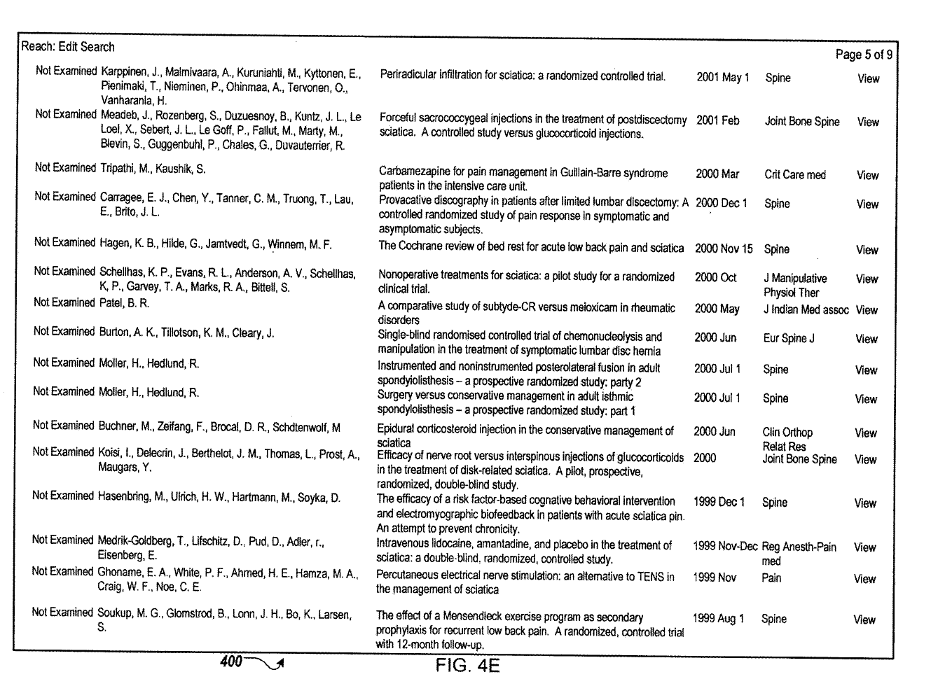

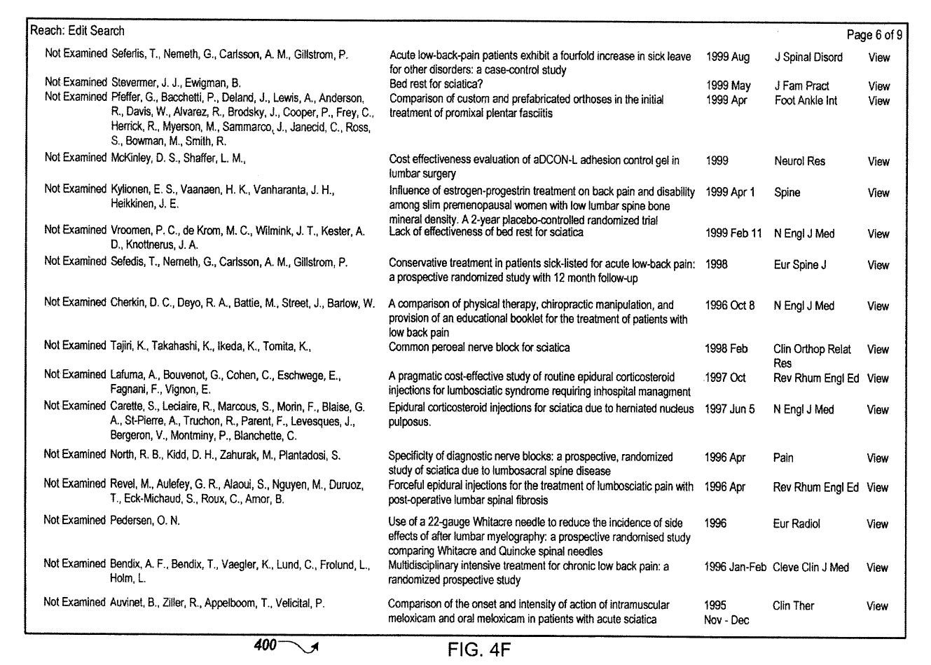

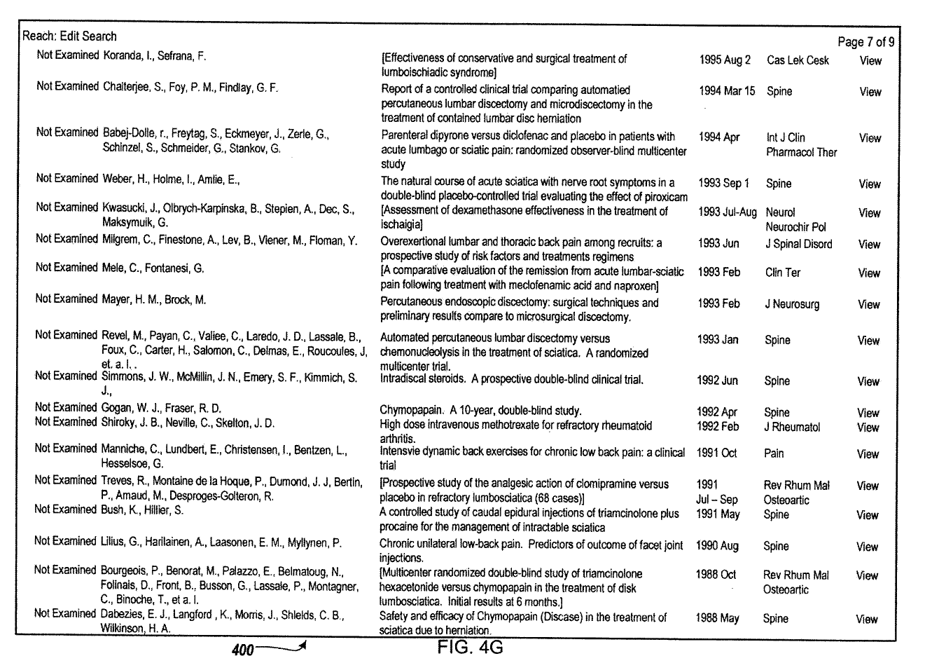

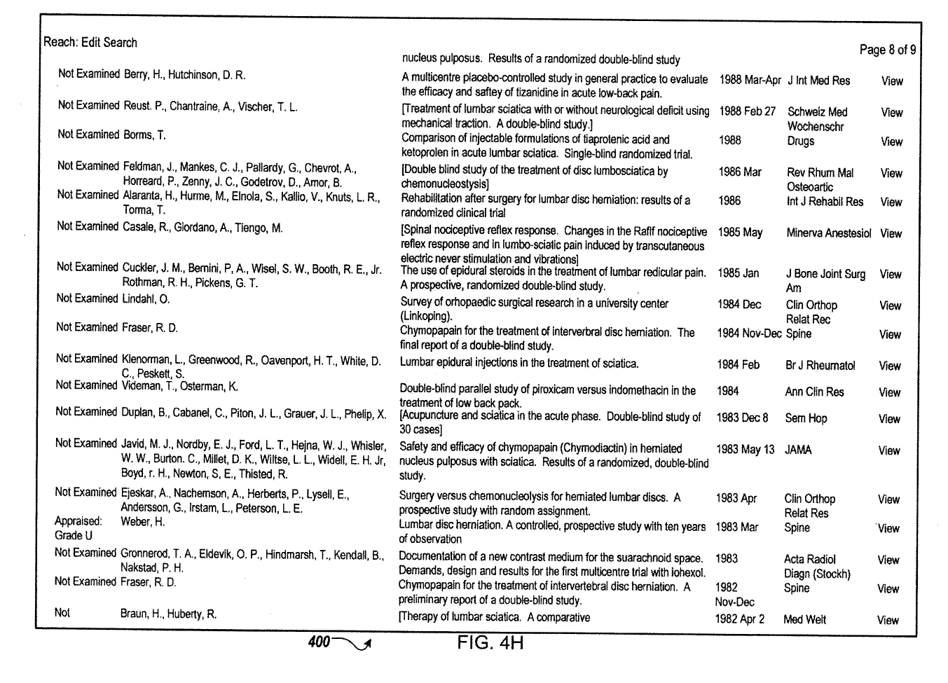

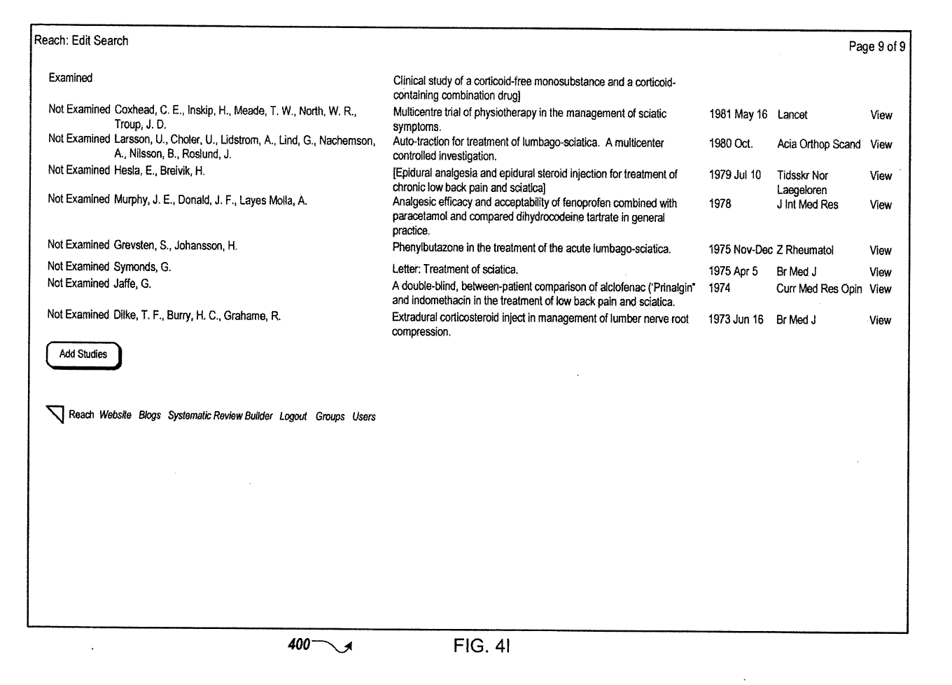

FIGS. 4A-I is an example of a user interface 400 illustrating a search result and the current status of appraising the search results. As illustrated, the current appraise topic 410, database utilized 420, search string utilized 430, and/or notes 440 may be presented through the interface 400. The search results 450 may also be presented. As illustrated, the search results 450 may include report information 453 (e.g., author, title, date, source), a link to the report 455, and status indicator 458. Status indicators 458 may include a link to select if the report is to be added to the reports to be appraised 460, an indication that the report has been appraised 463, a grade 465, and/or an indication 468 that the report has been considered by an appraiser to be not relevant and was thus not examined.

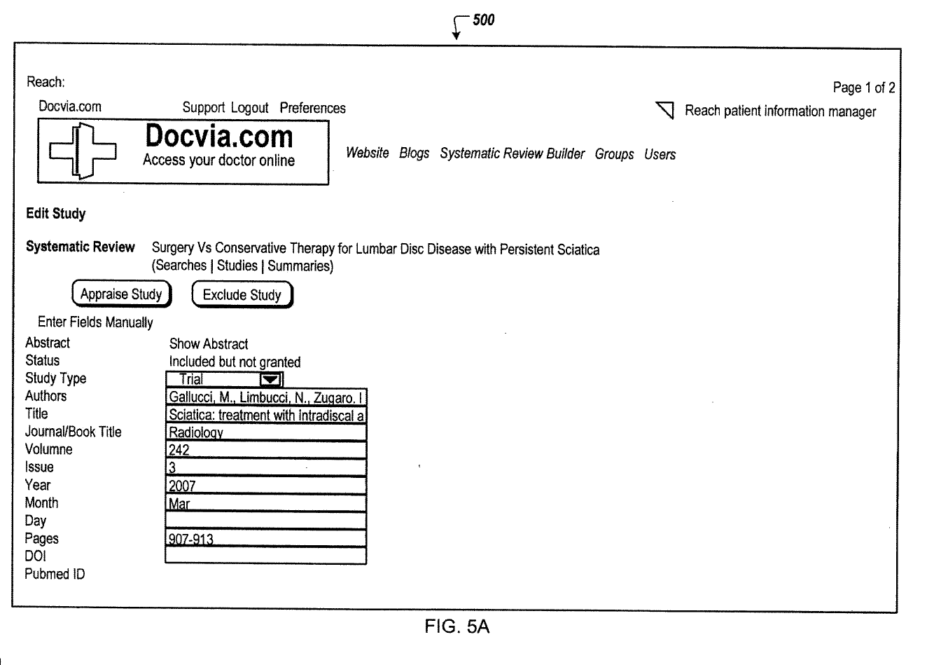

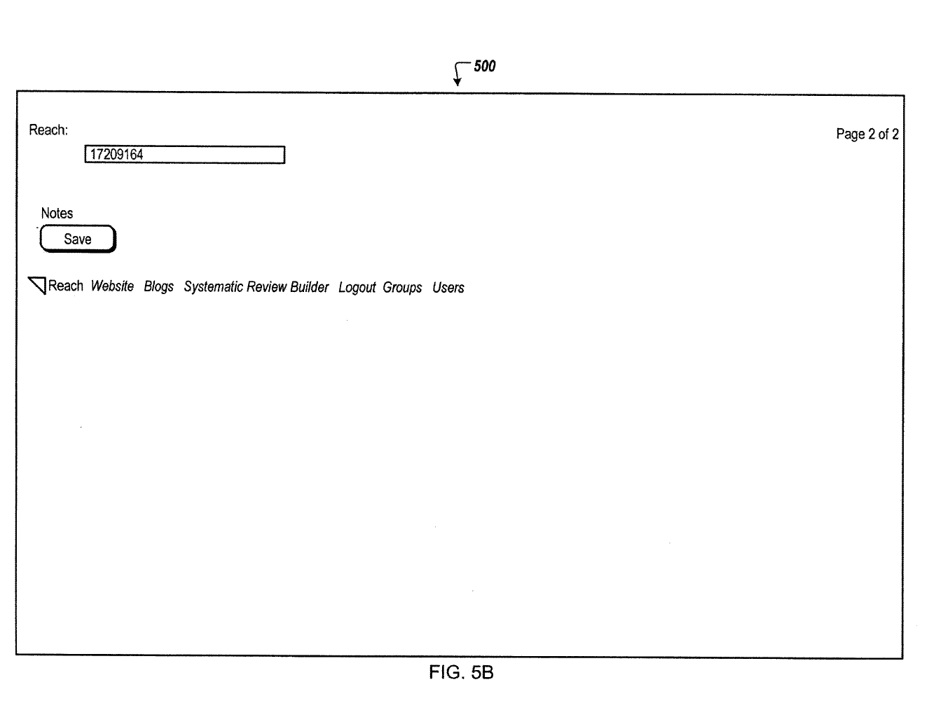

FIGS. 5A-B is an example of a user interface 500 illustrating the process for evaluating whether a study is relevant through an appraiser device. As illustrated, the interface 500 may include a template that is utilized to partially appraise a report.

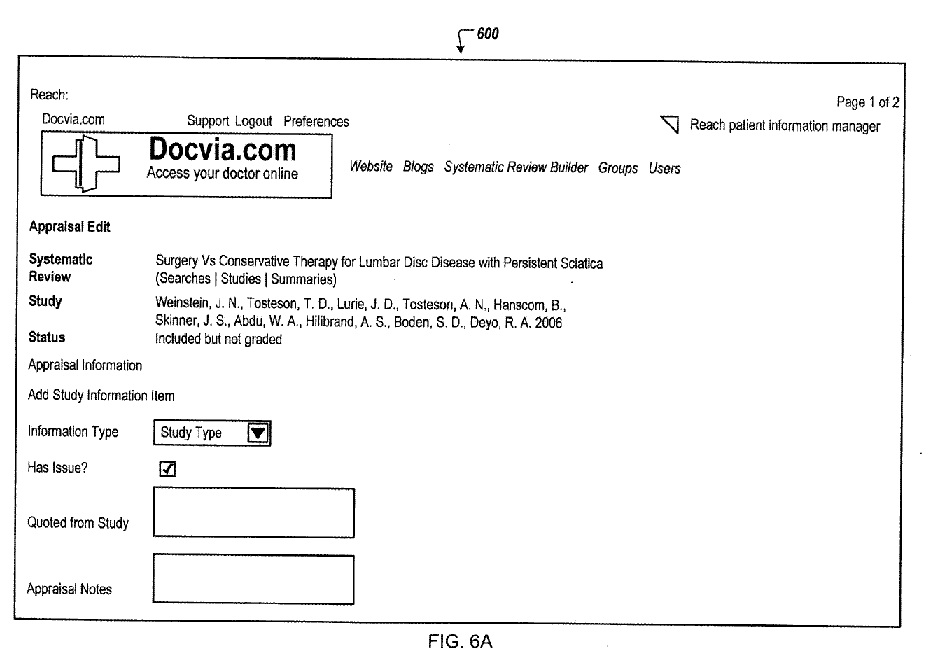

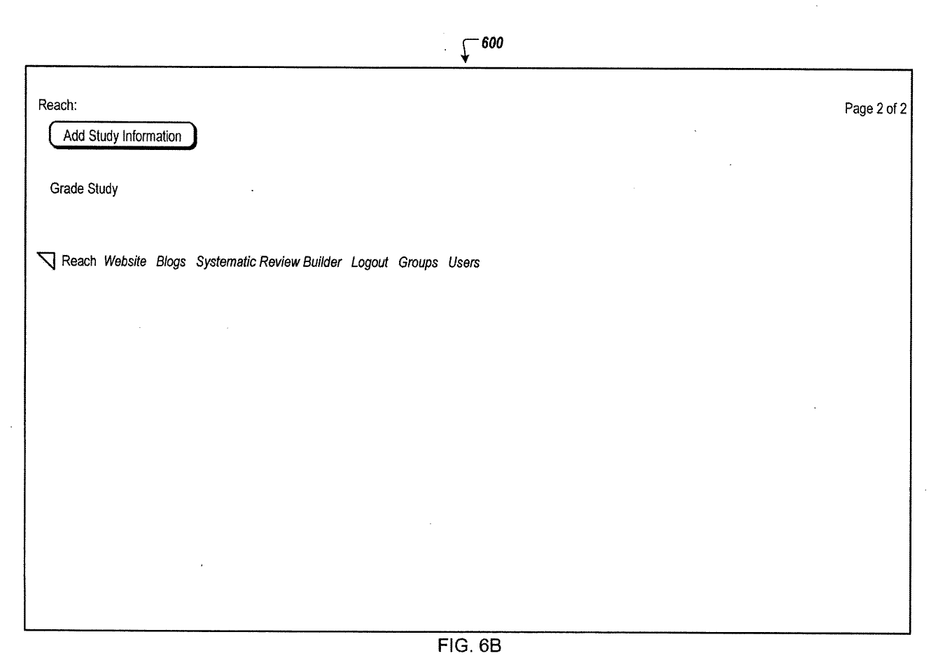

FIGS. 6A-B is an example of a user interface 600 illustrating the appraisal of a report through an appraiser device. As illustrated the interface 600 may be template based such that a user may be able to easily identify information from various appraisals.

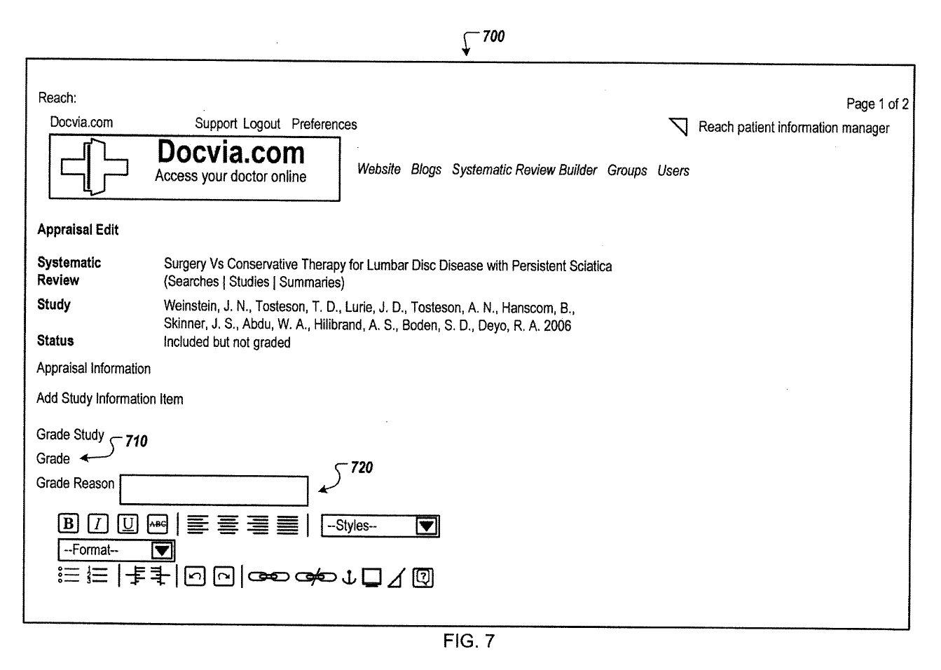

FIG. 7 is an example of a user interface 700 illustrating the grading of a report through an appraiser device. As illustrated, a grade 710 and a reason 720 for a grade selected may be provided through the interface 700.

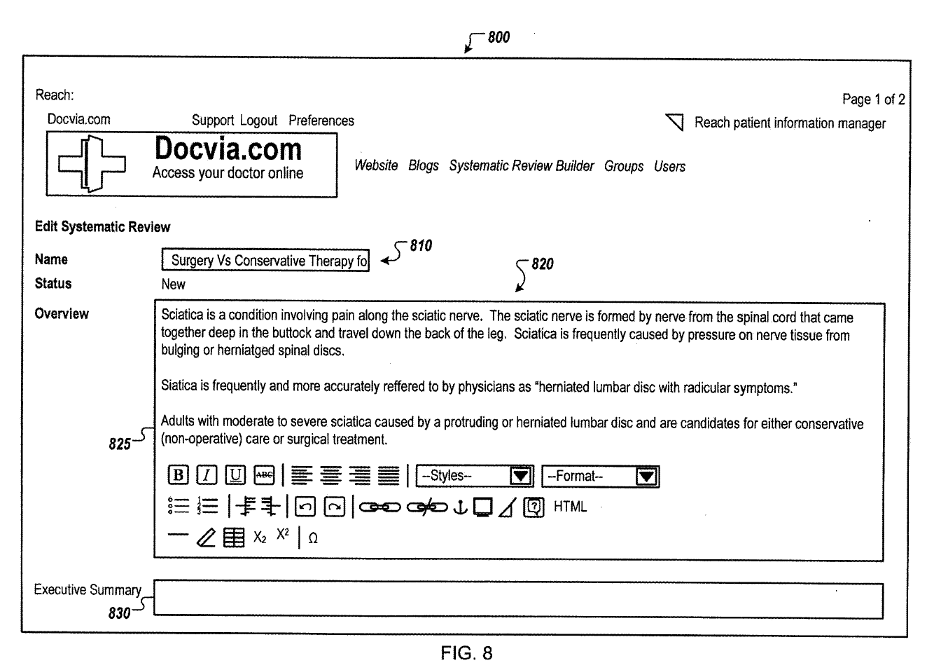

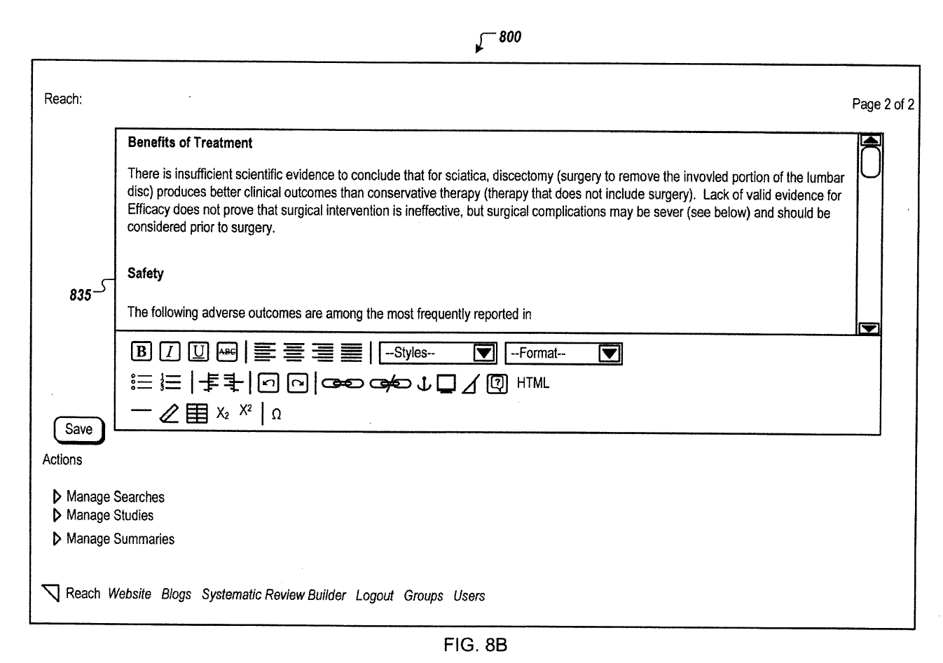

FIGS. 8A-B is an example of a user interface 800 illustrating the preparation of a summary through a primary appraiser device. As illustrated, the medical topic 810 may be provided and a summary field 820 may allow a summary to be associated with the medical topic. The summary 820 may include various portions such as an overview 825, executive summary 830, and/or reach 835. A chief appraiser may provide one or more of the portions of the summary 820.

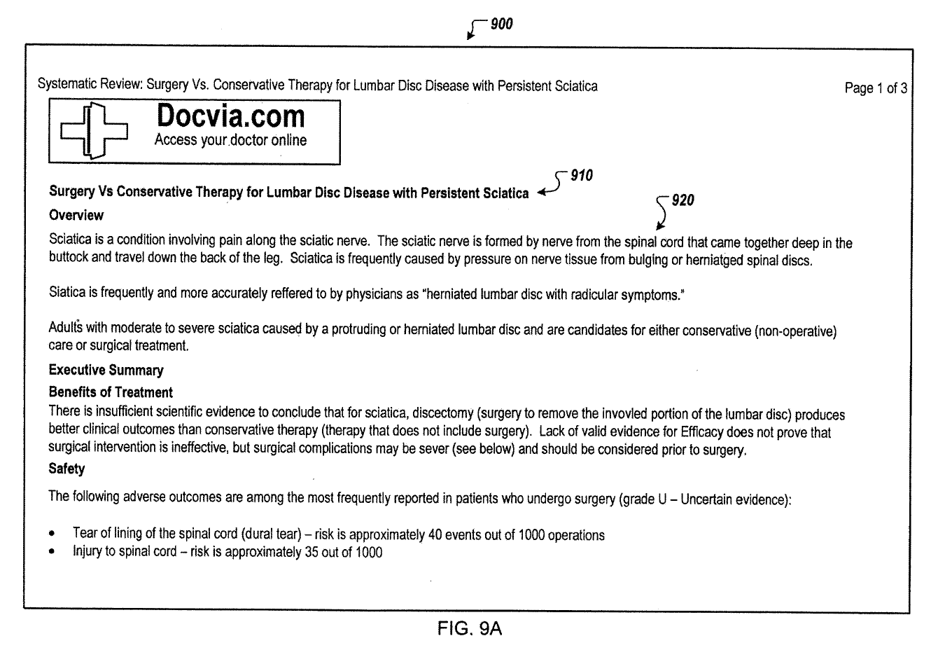

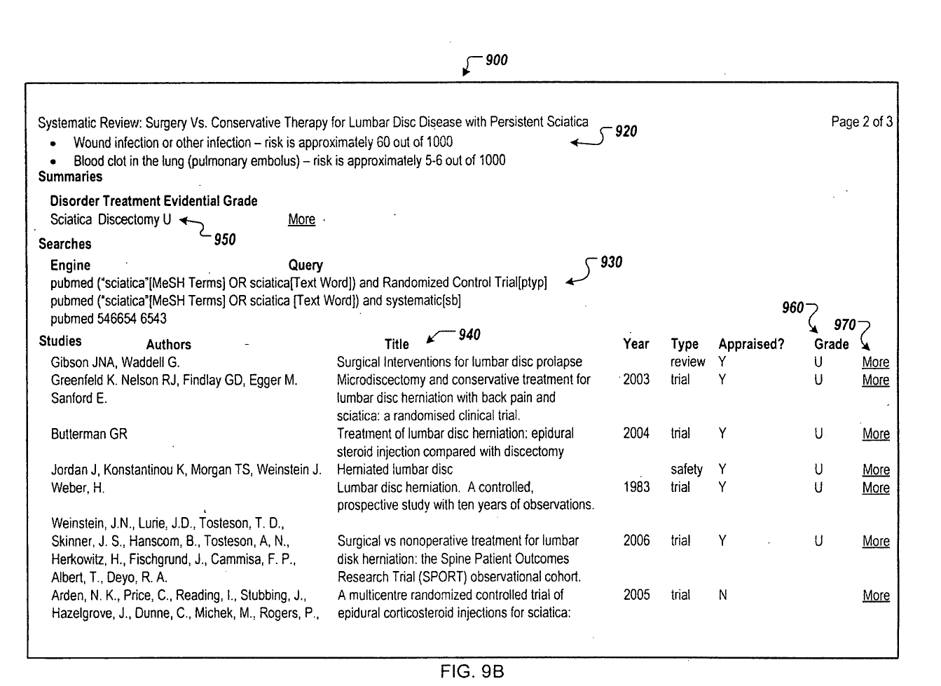

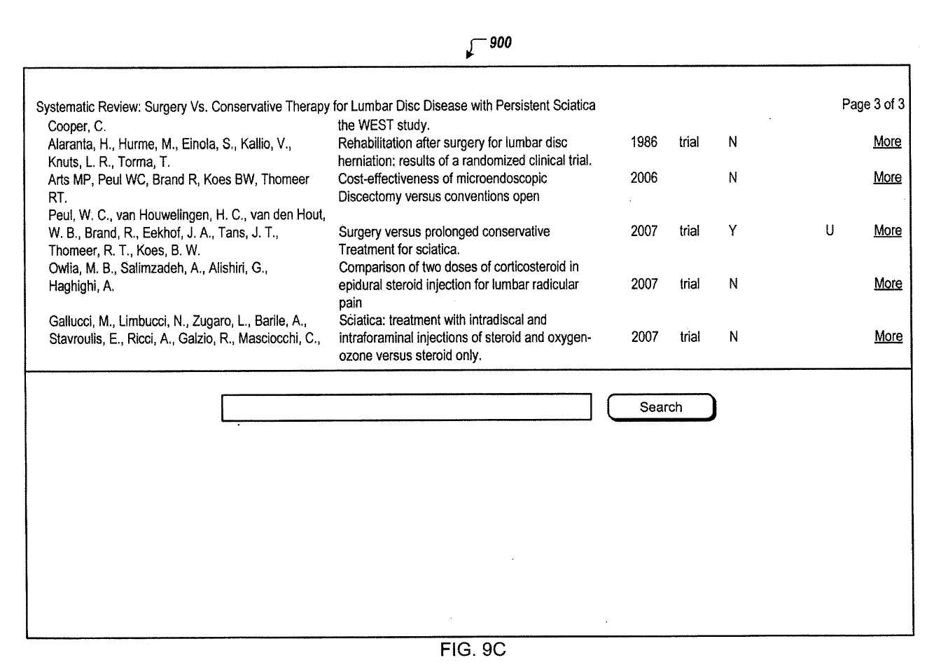

FIGS. 9A-C is an example of a user interface 900 illustrating an information site for users. As illustrated, a medical topic 910, a summary 920, searches executed in preparing the summary (e.g., from annotations) 930, and a listing 940 of reports associated with the medical topic may be presented through the interface. As illustrated, the chief appraiser may provide a grade for the treatment 950 based on the appraisal of the reports. The grades 960 assigned to the reports in the listing of reports and links to the appraisals 970 of the reports may also be provided through the interface 900.

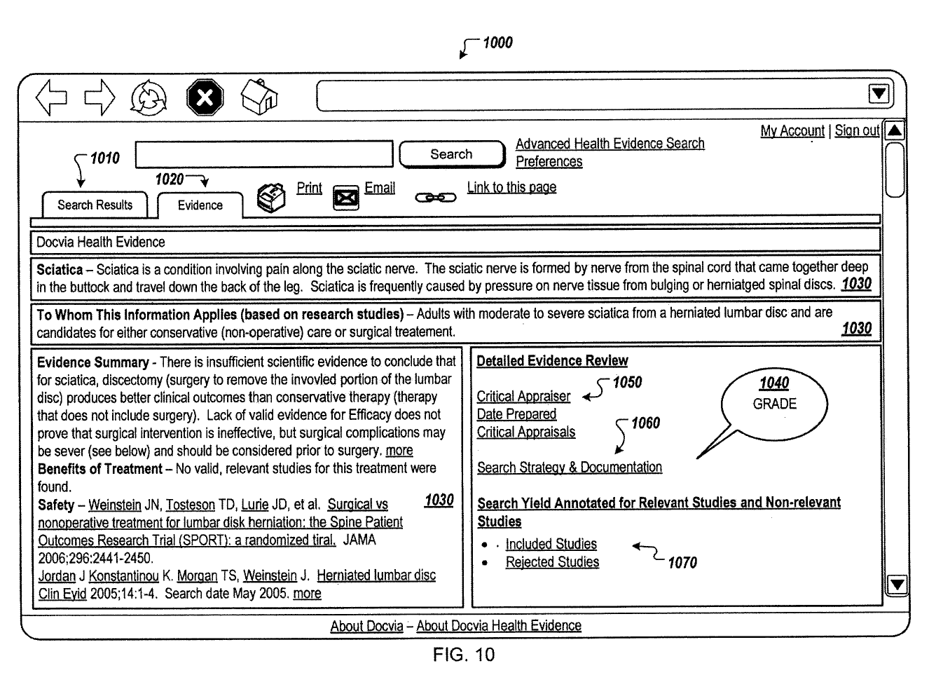

FIG. 10 is an example of a user interface illustrating another information site for users. As illustrated, access to the data distribution device data may be provided through a search engine. When medical terms are searched using the search engine, access to the data distribution device may be automatically obtained. The search results may then include the search results 1010 in one portion of the interface and an evidence portion 1020 of the interface, which provides information obtained from the data distribution device. As illustrated, a summary 1030, grades 1040, appraiser information 1050, search strategy used to prepare the summary 1060, and a link to relevant (e.g., according to the appraisals) reports 1070 may be presented.

As illustrated, this user interface may be presented through a commonly available Internet search engine. To arrive at this user interface, a user may have searched a particular condition—sciatica, in this example. For this search, the first 20 search results are ranked and designated as valid reports. The top ranked results is under a tab titled “Evidence”. Clicking on this tab opens a window for searching/view evidence. Several evidence categories (e.g., Sciatica: Treatment: Surgery) may be available for a topic. Also presented is a coded evidence grade. The evidence summary is written in plain English, and more information may be accessed regarding the systematic review and the references.

Implementations of various systems have been described above. As discussed therein, these systems may include one or more devices and/or articles of manufacture, which may incorporate one or more features. Thus, individual devices or articles of manufacture, or systems in which they are incorporated, may be of functional value.

Although a user (e.g., appraiser, end-user, etc.) has been described as a human, a user may be a person, a group of people, a person or persons interacting with one or more computers, and/or a computer system. A user computer may describe one or more computers and/or computer systems.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer (e.g., host or external host) having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user by an output device can be any form of sensory feedback (e.g., visual feedback, auditory feedback, or tactile feedback); and input from the user can be received in any form, including acoustic, speech, or tactile input.

The systems and techniques described here can be implemented in a computing system that includes one or more computers (e.g., a single computer, a distributed set of computers, a data server, an application server, or a client computer having a graphical user interface or a Web browser through which a user can interact with an implementation of the systems and techniques described here), or any combination of computers (e.g., a data server, application server and/or client computer). The components of the system can be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

In addition, the systems may include various security technologies that may restrict access to documents and data as appropriate. For example, users may need to provide user information (e.g., user name, password, biometric data, and/or combinations thereof) to receive access to the documents. In addition, data may be stored in a secure form on the system. Various other security technologies (e.g., cookies, private key infrastructures, public key infrastructures, etc.) may be implemented in the system to comply with government and/or industry regulations and/or standards.

A number of implementations have been described and several others have been mentioned or suggested. Additionally, those skilled in the art will readily recognize that a variety of additions, deletions, substitutions, combinations, and/or modifications may be made while still achieving medical data appraisal and distribution. Thus, the scope of the protected subject matter should be based on the following claims, which may encompass one or more features of one or more of the implementations. Other protectable subject matter has also been described.

What is claimed:

1. An article of manufacture comprising a machine-readable medium storing instructions for managing medical information, the instructions operable to cause data processing apparatus to perform operations comprising:
receiving a user request for information related to a medical topic;
retrieving a summary of the medical topic;
retrieving a listing of reports related to the medical topic and indications of results of evidence-based medicine appraisals of the reports, wherein the listing of reports includes reports appraised based on evidence-based medicine rules;
generating a user interface to present the summary, the listing of reports, and the appraisals.

2. The article of claim 1 wherein the user request includes search criteria, and wherein the instructions are further operable to cause data processing apparatus to perform operations comprising identifying a medical topic associated with the search criteria.

3. The article of claim 1 wherein the instructions are further operable to cause data processing apparatus to perform operations comprising receiving a second user request to appraise one of the reports in the listing of reports; and
generating an interface to present the evidence-based medicine appraisal of the report.

4. The article of claim 1 wherein the medical topic includes at least one of medical conditions, symptoms, diagnoses, or treatments.

5. The article of claim 1 wherein evidence-based medicine rules includes rules based on at least one of sample size, bias, control group, or length of study.

6. The article of claim 1 wherein the instructions are further operable to cause data processing apparatus to perform operations comprising generating the interface to present grades of reports presented in the listing of reports, and wherein a grade of a report is based on an appraisal of the report according to evidence-based rules.

7. The article of claim 6 wherein at least some of the reports in the listing of reports are ordered at least in part based on the grades of the reports.

8. The article of claim 1 wherein at least one of the reports in the listing of reports include an annotation, and wherein the instructions are further operable to cause data processing apparatus to perform operations comprising presenting information related to the appraisal of the report based on the annotation, when receiving a request for the information related to the appraisal.

9. The article of claim 1 wherein the instructions are further operable to cause data processing apparatus to perform operations comprising:
receiving a request for appraisals for the reports in the listing of reports; and
transmitting the appraisals for the reports to a user device.

10. The article of claim 1 wherein generating an interface to present the listing of reports comprises generating an interface to present reports with a grade greater than a specified value, wherein a grade of a report is based on an appraisal of the report according to evidence-based rules.

11. The article of claim 1 wherein the instructions are further operable to cause data processing apparatus to perform operations comprising:
storing a medical topic search criteria, wherein the summary of the medical topic is at least partially based on results of the search criteria;
automatically submitting the stored search criteria after a receiving a user request for information related to the medical topic;
receiving a second search result based on the submitted search criteria; and
identifying reports included in the second search result that were not included in a previous result based on the stored search criteria.

12. An article of manufacture comprising a machine-readable medium storing instructions for managing medical information, the instructions operable to cause data processing apparatus to perform operations comprising:
receiving search criteria related to a medical topic;
generating a search for reports related to the search criteria;
receiving search results based on the generated search, wherein the search results include a listing of reports;
generating an interface to present one or more reports in the listing of reports;
receiving one or more assignments of one or more of the reports in the listing of reports to appraisers for appraisal based on evidence-based medicine rules;
receiving a notification that an appraisal of one or more of the reports in the listing of reports has been appraised based on evidence-based medicine rules;
generating an interface to present one of more of the appraisals; and
receiving a summary of the medical topic based at least in part on the appraisals.

13. The article of claim 12 wherein the medical topic includes at least one of medical conditions, symptoms, diagnoses, or treatments.

14. The article of claim 12 wherein evidence-based medicine rules includes rules based on at least one of sample size, bias, control group, or length of study.

15. The article of claim 12 wherein the instructions are further operable to cause data processing apparatus to perform operations comprising:
storing the search criteria;
automatically submitting the search criteria after a specified period of time;
receiving a second search result; and
identifying reports included in the second search result that were not included in a previous result based on the search criteria.

16. The article of claim 15 wherein the instructions are further operable to cause data processing apparatus to perform operations comprising transmitting a notice related to the identification of reports that were not included in a previous search result.

17. The article of claim 15 wherein the instructions are further operable to cause data processing apparatus to perform operations comprising automatically assigning the identified reports based on previous assignments of reports in the previous search results.

18. The article of claim 15 wherein the instructions are further operable to cause data processing apparatus to perform operations comprising storing previous search results, wherein the identification of reports that are included in the second search result that were not included in a previous result includes comparing the second search results to stored previous search results.

19. The article of claim 15 wherein the instructions are further operable to cause data processing apparatus to perform operations comprising:
receiving one or more medical terms related to the medical topic; and
associating the received summary with one or more of the medical terms such that when a search including one or more of the medical terms is performed, the summary is retrieved.

20. The article of claim 12 wherein the instructions are further operable to cause data processing apparatus to perform operations comprising generating a template configured to receive rules for evidence-based medicine appraisals of the received listing of reports.

21. The article of claim 20 wherein the instructions are further operable to cause data processing apparatus to perform operations comprising:
receiving one or more rules to generate the template; and
transmitting generated template and received assignments to one or more appraisers.

22. An article of manufacture comprising a machine-readable medium storing instructions for managing medical information, the instructions operable to cause data processing apparatus to perform operations comprising:
receiving a listing of reports, related to a medical topic, assigned to an appraiser;
transmitting the listing of reports to the appraiser to whom the listing is assigned;
receiving appraisal rules, wherein the appraisal rules are utilized in the appraisal of reports according to evidence-based medicine rules;
transmitting the appraisal rules to the appraiser to whom the listing is assigned;
receiving an appraisal of one of the reports based on the received rules;
receiving an annotation of the report, wherein the annotation includes information related to the appraisal; and
associating the annotation with the report, such that when an report is presented the associated annotation is retrievable.

23. The article of claim 22 wherein the medical topic includes at least one of medical conditions, symptoms, diagnoses, or treatments.

24. The article of claim 22 wherein evidence-based medicine rules includes rules based on at least one of sample size, bias, control group, or length of study.

25. The article of claim 22 wherein the instructions are further operable to cause data processing apparatus to perform operations comprising storing the received appraisal.

26. The article of claim 22 wherein the instructions are further operable to cause data processing apparatus to perform operations transmitting a notice to the appraiser related to receiving the listing of reports.

27. The article of claim 22 wherein the instructions are further operable to cause data processing apparatus to perform operations transmitting a notice to a chief appraiser when appraisals for the reports in the listing of reports assigned to the appraiser have been received.

28. The article of claim 22 wherein the appraisal rules include rules related to a grade assigned to a report, and wherein receiving an appraisal of the report includes receiving a grade for the report.

29. The article of claim 22 wherein the annotations include at least one of search terms utilized to obtain the listing of reports related to a medical topic, a date when the search terms were utilized to obtain the listing of reports, appraiser identification information, chief appraiser identification information, reasons for grades, or appraiser notations.
